(19) United States
(12) Patent Application Publication
(10) Pub. No.: US 2008/0169315 A1
(43) Pub. Date: Jul. 17, 2008

(54) Dry portioner

(76) Inventor: Greg James Ivancich, Toms River, NJ (US)

Correspondence Address: Greg Ivancich, 1025 Monmouth Ave, Toms River, NJ, 08757, US

(21) Appl. No.: 11/653,694

(22) Filed: Jan. 16, 2007

(51) Int. Cl. G01F 11/26; B67D 5/08

(52) U.S. Cl. 222/454; 222/565

(57) ABSTRACT

While looking at the outside physical characteristics of a dry portioner it appears that there are like items available today. It is the internal elements that cause this device to be unique. These elements enable consistent portioning or measuring and dispensing of a dry item.

One unique element is the properties and existence of the inside storage hopper. This inside storage hopper allows for hands free measuring while the cone funnel bottom to the hopper not only helps facilitate the measuring or portioning but directly contribute to moving dry items portioned to the dispensing holes. When inverted the cone funnel now has slopes of a contrary degree which lead the dry item portioned down, if there was a flat bottom to the inside hopper not all the dry item would be moved to the dispensing holes, yielding an inconsistent measure.

In refillable versions the double sealed ring is unique and necessary to the performance of the device.

A handle does not make this dry portioner unique. One can be added or omitted with no bearing on the performance of the dry portioning.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

A dry portioner would primarily be utilized in, but not limited to the food and beverage industry. Its intent is to aid in consistently portioning or measuring, then dispensing a dry item, with out the use of any other measuring instrument except the portioner itself.

The quotations of multiple, national and international restaurant chains, top executives are not cited, as many of their articles are not published for commercial gain as noted in their publications.

Many articles are available from countless resources addressing the issues of consistency in a food and beverage operation,

The use of a dry protioner will address this issue of consistency, which is a dilemma in many food and beverage operations.

### BRIEF SUMMARY OF THE INVENTION

A dry portioning device is that which is able to contain or hold, measure and dispense dry items. Current options of a like item will only hold and dispense dry items. Today's versions lack one feature that is highly sought after in the food and beverage industry, and that is the ability to hold, portion and dispense dry items, not only at the point of sale, but in other commercial and consumer venues as well.

### DESCRIPTION OF DRAWINGS

FIG. 1 is an elevated side view of a dry portioner in its completed state

FIG. 2 is an elevated side view of a dry portioner with a portion of the outer container missing to show the internal elements. The outer container is removed from 2 o'clock to 10 o'clock

FIG. 3 is a top view of a washable version of a dry portioner showing how the hopper would be mounted to the sides while the top is accessible

FIG. 3a is an inside top view of a double sealed lid. The inner ring will seal the refillable hopper and the outer ring will seal the outer container

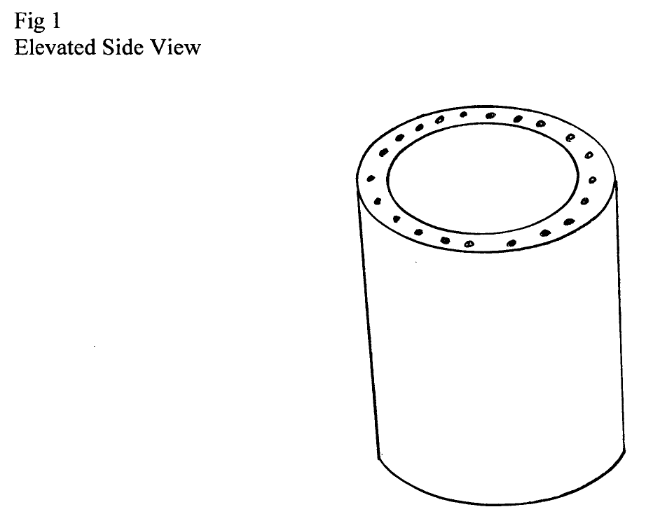

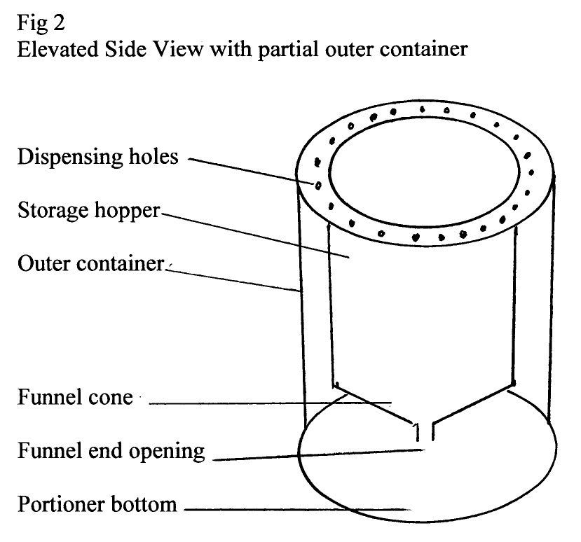

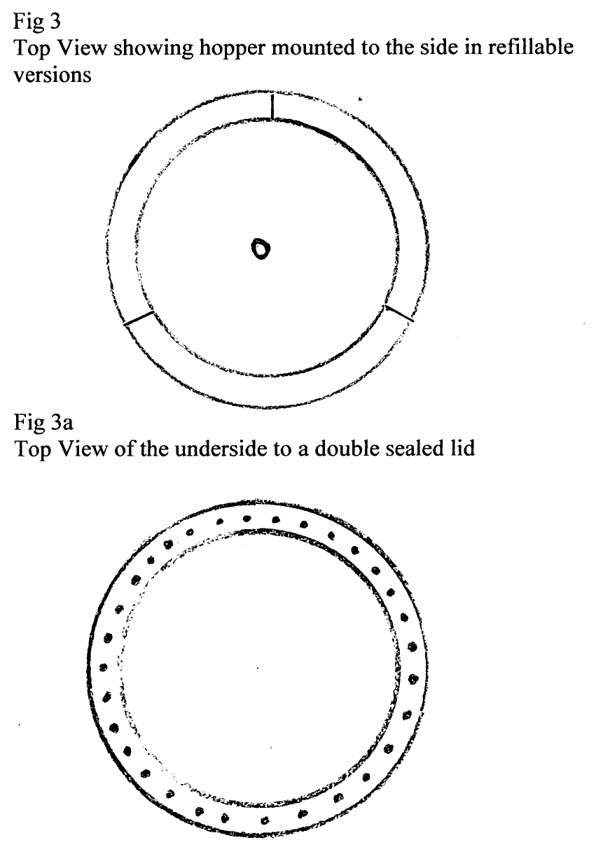

### DETAILED DESCRIPTION OF THE INVENTION

A dry portioner is a tool used to control quantities of dry items being dispensed. It can be made from sturdy plastics yielding a refillable and washable item or a single use version can be bonded from paper or like fibers.

In either scenario this dry portioner must be equipped with an inside storage hopper that is affixed at the bottom with a cone funnel creating one piece, a cylindrical shaped hopper that has a cone funnel opening at the bottom. Also, in either scenario this hopper and it's cone funnel opening will be suspended above the portioner bottom.

This hopper can be mounted on the sides of an outer sturdy cylinder in refillable versions to allow it to be refilled by leaving the top accessable. If this is the method used a unique lid with two sealing rings is required. One ring would seal the lid on the outer container and the other, inner ring would seal the refillable storage hopper. Adjustable units of measure can be offered by creating multiple mounting positions on washable versions.

In disposable models the hopper will be sealed and then affixed to the portioner top as this would simplify its production if it's to be discarded.

The inside storage hopper in any version will be completely enclosed by an outer container that is smooth and sturdy. The outer container is used to control and keep dry items after being portioned, now staged to be dispensed. When inverted the now portioned dry item will spill over the funnel, between the storage hopper and outer cylinder and be lead to the dispensing holes. There need not be any specific amount of space between the hopper and outer container. It needs to be wide enough for the dry items to travel to the dispensing holes yet should be as narrow as possible allowing the storage hopper to be as large as possible.

The distance of the funnel end opening from the bottom of the portioner will determine the unit of measure or portion size of the dry item. If the end opening is cut higher it will allow more of a dry item to move to the bottom of the portioner. If it hangs lower it will allow a smaller portion to accumulate in the portioner bottom. In either case flow of the dry item through the funnel opening will stop when the dry item accumulating has reached the funnel opening.

A manufacturer and or industry standards will help determine the most common units of measure or portion sizes used, as well as product mix, in regards to the contents of the storage hopper.

A dry portioner has a lid with holes that allow for dispensing of dry items.

Quantities of measure are not unique, a dry portioner can be offered in varied units of measure, refillable or disposable models. It's the method used to achieve a consistent portion that makes this tool unique.

The best mode contemplated by myself for bringing such an item to fruition, would to have it be constructed from heavy bond paper and paper board, in a disposable form. Size of openings and passages will be determined by the portioners contents and desired unit of measure. Certain coatings or processes may need to be added to paper for construction.

1. What I claim as my invention is, the use of an elevated, cone funnel shaped hopper, with an opening at the bottom will continue to move its contents of a dry item until the dry item itself has accumulated up to the opening, as long as this hopper is encompassed with an outer container. By combining all of the fore mentioned you can consistently measure and dispense a dry item.
Using a dry portioner will yield consistency in food and beverage operations as well as in other industrial operations or consumer uses, in applications where a dry portioner is used.
